(19) United States
(12) Patent Application Publication
(10) Pub. No.: US 2005/0129983 A1
(43) Pub. Date: Jun. 16, 2005

(54) Magnetic recording medium having a backside coating dispersion

(75) Inventor: Matthew N. Fraley, Minneapolis, MN (US)

Correspondence Address: Attn: Eric D. Levinson;Imation Corp., Legal Affairs, P.O. Box 64898, St. Paul, MN, 55164-0898, US

(73) Assignee: Imation Corp.

(21) Appl. No.: 10/738,595

(22) Filed: Dec. 15, 2003

(51) Int. Cl. G11B 5/68

(52) U.S. Cl. 428/694 BB; 428/694 BN; 428/694 BR

(57) ABSTRACT

A magnetic recording medium comprising a non-magnetic substrate having a front side and a backside having a magnetic layer formed over the front side of the substrate, wherein the magnetic layer includes magnetic pigment particles, and a binder system therefor; the substrate also has a coating layer formed over the backside of the substrate wherein it is formed from a dispersion substantially free of tetrahydrofuran. In one embodiment, the backside coating formulation further comprises a crosslinking agent including a tetramethylol propane adduct and a 1,3-butanediol adduct in a solution of methylethylketone.

### THE FIELD OF THE INVENTION

The present invention relates generally to magnetic recording tapes useful in belt driven tape cartridges, more specifically to a formulation for a backside coating for such magnetic recording tapes, which is formed from a dispersion free of tetrahydrofuran.

### BACKGROUND OF THE INVENTION

Belt-driven tape cartridges, or data cartridges, have been known for many years. The typical data cartridge includes a housing enclosing a pair of rotatably mounted tape hubs, or spools, about which tape is wound. A drive belt contacts the tape, and movement of the belt causes movement of the tape between the hubs. Belt driven tape cartridges are frequently used to interface with computers where high tape speeds and rapid acceleration and deceleration of the tape are required. Such cartridges typically employ magnetic recording tape as the data storage medium.

Magnetic recording media are widely used in audio tapes, video tapes, computer tapes, disks and the like. Magnetic media may use thin metal layers as the recording layers, or may comprise coatings containing magnetic particles as the recording layer. The latter type of recording media employs particulate materials such as ferromagnetic iron oxides, chromium oxides, ferromagnetic alloy powders and the like dispersed in binders and coated on a substrate. In general terms, magnetic recording media generally comprise a magnetic layer coated onto at least one side of a non-magnetic substrate (e.g., a film for magnetic recording tape applications). The formulation for the magnetic coating is optimized to maximize the performance of the magnetic recording medium in such areas as signal-to-noise ratios, pulsewidth, and the like.

Magnetic tapes may also have a backside coating applied to the opposing side of the non-magnetic substrate in order to improve the electrical conductivity and tracking characteristics of the media. The backside coating typically comprises a polymeric binder but may also include non-magnetic pigments, lubricant, thermal stabilizers, dispersants and/or surfactants, coating aids, and the like. As with the front coating, the backside coatings are typically combined with suitable solvents to create a homogeneous dispersion which is then coated onto the substrate, after which the coating is dried in an oven, calendered if desired, and then post cured via heat soak. The backside coating is important for mechanical properties. The solvent mixture from which the formulation is coated has a definite effect on the final properties of the magnetic tape as well as in the process of making said formulation. Certain solvents can strip away the wetting agent and polymer from dispersed pigment particles, causing shear flocculation of the pigment, which then floats at the top of the dispersion.

It would therefore be desirable to use a solvent mixture that would improve the rheology and coatability of the formulation and allow increased coating speeds and minimize pigment float, thus possibly improving the durability of the coating. It has now been discovered that using a backside coating substantially free of tetrahydrofuran (THF) will reduce pigment flooding and subsequent pigment build-up on coating equipment. Removal of THF from the solvent mixture in the dispersion will also allow the dispersion the flexibility of using toluene diisocyanate as an activator instead of a methylene diisocyanate activator. One advantage of using toluene diisocyanate in a backside THF-free formulation is that there is no free methylene diisocyanate present to build up on the calendar stack rolls over time. Such build-up typically requires in-line cleaning. Also the filter pressure of the dispersion upon application over the substrate will remain stable over the duration of coating when using a toluene diisocyanate activator in a backside that does not contain high amounts of THF. Use of the THF-free solvent mixture will allow for further control of the coating's overall evaporation rate thus providing a smoother backside coating.

### SUMMARY OF THE INVENTION

The invention provides a magnetic recording medium including a non-magnetic substrate, having a magnetic coating on the front side of the substrate and a backside coating on the opposing side of the substrate. The magnetic layer contains a primary metallic particulate pigments, and a binder system therefor. The back coating formed on the opposing surface of the substrate, comprises at least one pigment and a binder system therefor, is formed from a dispersion which is substantially free of the solvent, tetrahydrofuran.

Specifically, a magnetic recording medium of the invention comprises a non-magnetic substrate having a front side and a backside, a magnetic layer formed over the front side of the substrate comprising magnetic pigment particles, and a binder system therefor; said substrate also having a backcoating layer formed over said backside. The said backside coating is formed from at least one pigment and a binder system therefor, wherein the binder system therefor formed from a dispersion which is substantially free of tetrahydrofuran, wherein the dispersion has reduced pigment float when compared to an otherwise identical system containing tetrahydrofuran.

In one embodiment, the magnetic recording medium of the invention comprises a non-magnetic substrate having a front side and a backside, a magnetic layer formed over said front side of said substrate, said magnetic layer comprising magnetic pigment particles, and a binder system therefor; said substrate also having a backside coating layer formed over said backside, said backside coating formed from a dispersion comprising at least one polymeric binder, and at least one polyisocyanate crosslinking agent and a solvent blend comprising a plurality of solvents selected from the group consisting of methylethylketone, toluene, and cyclohexanone.

The invention further provides a process for making a magnetic recording medium using a faster coating speed because of the nature of the solvent used. Specifically, the method for making a magnetic recording medium according to the invention comprises a coating step for the inventive backside coating layer wherein the coating layer is applied at a speed of at least about 500 feet/minute and most preferably at least about 800 feet/minute. Coating speeds of at least 1000 feet/minute are also possible.

These terms when used herein have the following meanings.

1. The term “coating composition” means a composition suitable for coating onto a substrate.

2. The terms “layer” and “coating” are used interchangeably to refer to a coated composition.

3. The terms “back coating” and “backside coating” are synonymous and refer to a coating on the opposing side of the substrate from a magnetic layer.

4. The term “vinyl” when applied to a polymeric material means that the material comprises repeating units derived from vinyl monomers. When applied to a monomeric material, the term “vinyl” means that the monomer contains a moiety having a free-radically polymerizable carbon-carbon double bond.

5. The term “resistivity” means the surface electrical resistance measured in Ohms/square.

6. The term “Tg” means glass transition temperature.

7. The term “coercivity” means the intensity of the magnetic field needed to reduce the magnetization of a ferromagnetic material to zero after it has reached saturation, taken at a saturation field strength of 10,000 Oersteds.

8. The term “Oersted,” abbreviated as Oe, refers to a unit of magnetic field in a dielectric material equal to 1/μ Gauss, where μ is the magnetic permeability.

9. The term “Wyko Ra” refers to the average roughness of a coating, measured using a laser interferometer from Veeco Instruments, Inc.

All weights, amounts and ratios herein are by weight, unless otherwise specifically noted.

### DETAILED DESCRIPTION OF THE PREFERRED EMBODIMENTS

The following detailed description describes certain embodiments and is not to be taken in a limiting sense. The scope of the present invention is defined by the appended claims.

The magnetic recording medium includes a non-magnetic substrate, a magnetic layer, and a backside coating or layer. The various components are described in greater detail below. In general terms, however, the magnetic layer includes a primary magnetic metal pigment, and a binder for the pigment. The backside coating includes a combination of pigments including a primary non-magnetic pigment, and the backside coating is formed from a dispersion having a solvent mixture which is substantially free of tetrahydrofuran.

The Back Coat

The back coat contains one or more soft magnetic or non-magnetic particulate materials such as carbon black, alumina, silicone dioxide, titanium dioxide and the like.

Back coat pigments are dispersed as inks with appropriate binders, surfactant, ancillary particles, forming a binder system, and solvents therefor. Preferably, the back coat binder system includes at least one of a polyurethane resin, a phenoxy resin, and nitrocellulose blended appropriately to modify coating stiffness as desired.

In one embodiment, the back coat layer comprises a combination of two kinds of carbon blacks, including a primary, small carbon black component and a secondary, large texture carbon black component, in combination with appropriate binder resins. The primary, small carbon black component preferably has an average particle size on the order of from about 10 to about 50 nm, whereas the secondary, large carbon component preferably has an average particle size on the order of from about 50 to about 300 nm. The back coat of the magnetic recording medium of the present invention contains from about 5 to about 20 percent large particle carbon particles based on total composition weight, and from about 25 to about 40 percent small particle carbon particles based on total composition weight.

Dispersions for forming backside coating layers of the invention may further comprise one or more wetting agents. Useful wetting agents include lecithin, emcol acetate, phosphorylated polyoxyalkyl polyols, surfactants, a dispersant available from Byk-Chemie as Disperbyk-161, and the like.

Useful solvents to create dispersions of the invention include methylethylketone, toluene, cyclohexanone, and blends thereof, as well as other solvents or solvent combinations including, for example, xylene, methyl isobutyl ketone, and methyl amyl ketone, are acceptable.

The solvent mixtures of the invention are substantially free of tetrahydrofuran, which has previously been used as a solvent. By eliminating this solvent from the mixture of solvents used, the flooding of pigments, especially titanium dioxide, is reduced when compared to an otherwise identical dispersion containing tetrahydrofuran.

In one embodiment, the solvent used to disperse the pigments and resins of the backcoating formulation is a blend of methylethylketone (MEK), toluene (TOL), and cyclohexanone. Solvent blends may contain about 60 percent to about 80 percent of MEK, from about 20 to about 30 percent of toluene, and from about 1 to about 10 percent of cyclohexanone.

The dispersion formulation for the backcoating further includes an activator, or crosslinking agent. In one embodiment, the activator has a chemical formulation including about 50% of a tetramethylol propane (TMP) adduct, and about 50% of a 1,3-butanediol adduct in methylethylketone. This activator is available as CB-55 from Bayer AG.

Backside layers formed from coating formulations of the invention have improved smoothness. Conventional back coat formulations using tetrahydrofuran have Wyko Ra roughness values of about 147 nm. Backside formulations of the invention have Wyko Ra values of no more than about 90 nm. When preferred activators are used, the Wyko Ra roughness values are less than 85 nm.

The Magnetic Recording Layer

In accordance with the current invention, the magnetic recording layer is a thin layer, being preferably from about 1 microinch (0.025 μ) to about 10 microinches (0.25 μ) in thickness, preferably from about 1 microinch to about 8 microinches.

The magnetic metal particle pigments have a composition including, but not limited to, metallic iron and/or alloys of iron with cobalt and/or nickel, and magnetic or non-magnetic oxides of iron, other elements, or mixtures thereof Alternatively, the magnetic particles can be composed of hexagonal ferrites such as barium ferrites. In order to improve the required characteristics, the preferred magnetic powder may contain various additives, such as semi-metal or non-metal elements and their salts or oxides such as Al, Nd, Si, Co, Y, Ca, Mg, Mn, Na, etc. The selected magnetic powder may be treated with various auxiliary agents before it is dispersed in the binder system, resulting in the primary magnetic metal particle pigment. Preferred pigments have an average particle length of about 150 nanometers (nm). Such pigments are readily commercially available from companies such as Toda Kogyo, Kanto Denka Kogyo, and Dowa Mining Company.

In addition to the preferred primary magnetic metal particle pigment described above, the magnetic layer further includes soft spherical particles. Most commonly these particles are comprised of carbon black. A small amount, preferably less than about 3%, of at least one large particle carbon material may also be included, preferably a material that includes spherical carbon particles. The large particle carbon materials have a particle size on the order of from about 50 to about 500 nm, more preferably from about 70 to about 300 nm. Spherical large carbon particle materials are known and commercially available, and in commercial form can include various additives such as sulfur to improve performance. The remainder of the carbon particles present in the layer are small carbon particles, i.e., the particles have a particle size on the order of less than 100 nm, preferably less than about 50 nm.

The magnetic layer also includes an abrasive or head cleaning agent (HCA) component. One preferred HCA component is aluminum oxide. Other abrasive grains such as silica, ZrO₂, Cr₂O₃, etc., can also be employed, either alone or in mixtures with aluminum oxide or each other.

The binder system associated with the magnetic layer preferably incorporates at least one binder resin, such as a thermoplastic resin, in conjunction with other resin components such as binders and surfactants used to disperse the HCA, a surfactant (or wetting agent), and one or more hardeners. In one preferred embodiment, the binder system of the magnetic layer includes at least one hard resin component and at least one soft resin component in conjunction with the other binder components. Hard resin components typically have a glass transition temperature (Tg) of at least about 70° C., and soft resin components typically have a glass transition temperature of less than about 68° C.

In one embodiment, the magnetic layer comprises a binder system including both a polyurethane resin and a non-halogenated vinyl resin. Examples of polyurethanes include polyether-polyurethane, polyester-polyurethane, polycarbonate-polyurethane, polyester-polycarbonate-polyurethane, and polycaprolactone-polyurethane. Non-halogenated vinyl resins comprising styrene and acrylonitrile monomers can also be employed with the primary polyurethane binder, if desired.

In one preferred embodiment, the primary polyurethane binder is incorporated into the magnetic layer in an amount of from about 2 to about 10 parts by weight, and preferably from about 4 to about 8 parts by weight, based on 100 parts by weight of the primary magnetic layer pigment, and the non-halogenated vinyl binder is incorporated in an amount of from about 7 to about 15 parts by weight, and preferably from about 8 to about 10 parts by weight, based on 100 parts by weight of the primary magnetic layer pigment.

The binder system further preferably includes an HCA binder used to disperse the selected HCA material, such as a polyurethane paste binder (in conjunction with a pre-dispersed or paste HCA). Alternatively, other HCA binders compatible with the selected HCA format (e.g., powder HCA) are acceptable. As with other ingredients, HCA may be added to the main dispersion separately or dispersed in the binder system, and then added to the main dispersion.

The magnetic layer may further contain one or more lubricants such as a fatty acid and/or a fatty acid ester. The incorporated lubricant(s) exist throughout the front coating and, importantly, at the surface thereof the magnetic layer. The lubricant(s) reduces friction to maintain smooth contact with low drag, and protects the media surface from wear.

Preferred fatty acid lubricants include at least 90 percent pure stearic acid. Although technical grade acids and/or acid esters can also be employed for the lubricant component, incorporation of high purity lubricant materials ensures robust performance of the resultant medium. Other acceptable fatty acids include one or more of myristic acid, palmitic acid, oleic acid, etc., and their mixtures. The magnetic layer formulation can further include one or more fatty acid esters such as butyl stearate, isopropyl stearate, butyl oleate, butyl palmitate, butyl myristate, hexadecyl stearate, and oleyl oleate.

In a preferred embodiment, the lubricant is incorporated into the magnetic layer in an amount of from about 1 to about 10 parts by weight, and preferably from about 1 to about 5 parts by weight, based on 100 parts by weight of the primary pigment.

The binder system may also contain a conventional surfactant or wetting agent. Known surfactants, e.g., adducts of sulfuric, sulfonic, phosphoric, phosphonic, and carboxylic acids, are acceptable.

The coating composition may also contain a hardening agent such as isocyanate or polyisocyanate. In a preferred embodiment, the hardener component is incorporated into the magnetic layer in an amount of from about 1 to about 5 parts by weight, and preferably from about 1 to about 3 parts by weight, based on 100 parts by weight of the primary magnetic pigment.

The materials for the magnetic layer are mixed with the primary pigment and coated atop the substrate. Useful solvents associated with the magnetic layer coating material preferably include cyclohexanone (CHO), with a preferred concentration of from about 5% to about 50%, methyl ethyl ketone (MEK) preferably having a concentration of from about 40% to about 90%, and toluene (Tol), of concentrations from about 0% to about 40%. Alternatively, other ratios can be employed, or even other solvents or solvent combinations including, for example, xylene, methyl isobutyl ketone, tetrahydrofuran, and methyl amyl ketone, are acceptable.

Substrate

The substrate can be any conventional non-magnetic film substrate useful as a magnetic recording medium support. Exemplary substrate materials useful for magnetic recording tapes include polyesters such as polyethylene terephthalate (PET), polyethylene naphthalate (PEN), a mixture of polyethylene terephthalate and polyethylene naphthalate; polyolefins (e.g., polypropylene); cellulose derivatives; polyamides; and polyimides. Thickness of the film may vary from about 175 microinches to about 50 microinches in thickness.

Process for Manufacture

The coating materials of the front layer and back coat according to the present invention are prepared by dispersing the corresponding powders or pigments and the binders in a solvent. For example, with respect to the coating material for the magnetic layer, the primary metal particle powder or pigment and the large particle carbon materials are placed in a high solids mixing device along with certain of the resins (i.e., polyurethane binder, non-halogenated vinyl binder, and surfactant) and the solvent and processed for from about 1 to about 4 hours. The resulting material is processed in a high-speed impeller dissolver for about 30 to about 90 minutes, along with additional amounts of the solvent. Following this letdown processing, the resulting composition is subjected to a sandmilling or polishing operation. Subsequently, the HCA and related binder components are added, and the composition left standing for about 30 to about 90 minutes. Following this letdown procedure, the composition is processed through a filtration operation, and then stored in a mixing tank at which the hardener component and lubricants are added. The resulting material is then ready for coating.

Preparation of the back coat coating material preferably entails mixing the various components, including a solvent for a given duration, and then subjecting the dispersion to a sandmilling operation. Subsequently, the material is processed through a filtration operation in which the material is passed through a number of filters.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof

### EXAMPLE 1 AND COMPARATIVE EXAMPLE C1

Substrates were coated with backcoating layers coated from formulations containing TF (Example C1) and THF-free (Example 1) according to conventional coating techniques. The backcoating layers were then tested for average Wyko Roughness (Wyko Ra), using a laser interferometer from Veeco Instruments, Inc. Example C1 had a Ra value of 146.95 nanometers (nm). Example 1 had a Ra value of 89.29 nm, a difference of more than 57.6 nm, showing that magnetic recording media using THF-free solvent mixtures of the invention have improved smoothness over backside coatings coated from conventional dispersions using solvent mixtures including THF.

1. A magnetic recording medium comprising a non-magnetic substrate having a front side and a backside, a magnetic layer formed over said front side of said substrate, said magnetic layer comprising magnetic pigment particles, and a binder system therefor; said substrate also having a backside coating layer formed over said backside, said backside coating formed from a dispersion wherein said dispersion includes at least one pigment, at least one binder and a solvent blend, said solvent mixture being substantially free of tetrahydrofuran.

2. A magnetic recording medium according to claim 1, comprising a non-magnetic substrate having a front side and a backside, a magnetic layer formed over said front side of said substrate, said magnetic layer comprising magnetic pigment particles, and a binder system therefor; said substrate also having a backside coating layer formed over said backside, said backside coating formed from a dispersion comprising a solvent blend comprising methylethylketone, toluene, and cyclohexanone.

3. A magnetic recording medium comprising a non-magnetic substrate having a front side and a backside, a magnetic layer formed over said front side of said substrate, said magnetic layer comprising magnetic pigment particles, and a binder system therefor; said substrate also having a backside coating layer formed over said backside, said backside coating formed from a dispersion comprising at least one polymeric binder, and at least one polyisocyanate crosslinking agent and the solvent blend of claim 2.

4. A magnetic recording medium according to claim 2, wherein said solvent blend contains about 60 percent to about 80 percent of MEK, from about 20 to about 30 percent of toluene, and from about 1 to about 10 percent of cyclohexanone.

5. A magnetic recording medium according to claim 4, comprising from about 70 percent to about 80 percent of MEK, from about 20 to about 25 percent of toluene, and from about 1 to about 5 percent of cyclohexanone.

6. A magnetic recording medium according to claim 1, having a Wyko Ra roughness of no more than about 90.

7. A magnetic recording medium according to claim 1, wherein said backside coating comprises carbon black.

8. A magnetic recording medium according to claim 1, comprising at least one urethane resin binder.

9. A magnetic recording medium according to claim 3, wherein the back coat includes a carbon black pigment, a urethane binder, and at least one compound selected from phenoxy resin and nitrocellulose.

10. A magnetic recording medium according to claim 9, wherein the back coat further comprises a metal oxide selected from the group consisting of titanium dioxide, aluminum oxide and mixtures thereof.

11. A magnetic recording medium according to claim 1, further comprising a crosslinking agent.

12. A magnetic recording medium according to claim 11, wherein said crosslinking agent is a mixture of a tetramethylol propane adduct, and a 1,3-butanediol adduct in a solution of methylethylketone.

13. A magnetic recording medium according to claim 12, wherein said each of said adducts in said mixture comprises about 50% of said mixture.

14. A magnetic recording medium according to claim 13, wherein said back coat layer has a Wyko Ra roughness of less than about 89.

15. A magnetic recording medium according to claim 1, wherein said magnetic layer has a thickness of from about 0.25 micron to about 1.0 micron.

16. A magnetic recording medium according to claim 1, wherein the magnetic layer comprises a primary ferromagnetic pigment, aluminum oxide, a spherical large particle carbon material, a polyurethane binder, a non-halogenated vinyl binder, a hardener, a fatty acid ester lubricant, and a fatty acid lubricant.

17. A method for making a magnetic recording medium according to claim 1, comprising a coating step for coating said backside coating layer onto said substrate, said coating being applied at a rate of at least about 500 feet/minute.

18. A method for making a magnetic recording medium according to claim 17, wherein said backside coating is applied at a rate of at least about 800 feet/minute.

19. A method for making a magnetic recording medium according to claim 17, wherein said backside coating is applied at a rate of at least about 1000 feet/minute.
